(19) United States
(12) Patent Application Publication
(10) Pub. No.: US 2007/0133756 A1
(43) Pub. Date: Jun. 14, 2007

(54) PERSONAL NOTIFICATION METHOD AND APPARATUS

(76) Inventors: Samuel Raymond Graves III, Cicero, IN (US); Brice Raymond Bowman, Indianapolis, IN (US); Jon Erik Graves, San Diego, CA (US); Timothy Paul Hathaway, San Diego, CA (US)

Correspondence Address: Intellectual Property Group;Bose McKinney & Evans LLP, Suite 2700, 135 North Pennsylvania Street, Indianapolis, IN, 46204, US

(21) Appl. No.: 11/608,618

(22) Filed: Dec. 8, 2006

Related U.S. Application Data
(60) Provisional application No. 60/748,953, filed on Dec. 9, 2005.
(60) Provisional application No. 60/757,286, filed on Jan. 9, 2006.

(51) Int. Cl. H04M 11/04

(52) U.S. Cl. 379/37

(57) ABSTRACT

A system for notifying users of announcements concerning activities of interest using a plurality of hailing devices. The apparatus includes a central computer, a plurality of hailing devices, a transmitter for sending messages from the central computer to any hailing device, an activity database and a notification list associating hailing devices with activities. The method includes associating a hailing device with each user, maintaining the notification list, and monitoring the activity database for announcements concerning the activities. When an announcement is detected fro a monitored activity, the system searches the notification list for all relevant entries, determines the affected hailing devices associated with the monitored activity; and sends a notification message to the affected hailing devices. Each affected hailing device alerts the user of the notification message, and enables the user to perceive the notification message. The system can also translate or use templates to communicate messages in different languages.

### CROSS REFERENCE TO RELATED APPLICATIONS

This application claims the benefit of U.S. Provisional Application Ser. No. 60/748,953, filed on Dec. 9, 2005, entitled “Personal Notification Method and Apparatus,” and claims the benefit of U.S. Provisional Application Ser. No. 60/757,286, filed on Jan. 9, 2006, entitled “Personal Notification Method and Apparatus with Kiosk,” which are both incorporated herein by reference.

### BACKGROUND OF THE INVENTION

There are many situations in which it is important that a person is kept apprised of changes or announcements concerning an activity. This can sometimes be very difficult, especially when aggravating circumstances come into play. For example, passengers at an airport need to be kept apprised of the gate and departure time for their flight and any changes to these parameters. This can be very difficult for a person with impaired senses, or a person that does not understand the local language, or even a person that understands the local language but would like to leave the gate area. If many of the people in the gate area get up and start moving to someplace else, a person who cannot hear or understand announcements may feel compelled to move with the rest of the people, not sure what they have heard, but sensing the need to follow the other people who were in the gate area.

Travelers need to receive routine and emergency information to facilitate their travel needs from the travel terminal administration or other knowledgeable entity. Travelers without sensory impairments that understand the language have little difficulty negotiating travel terminals, such as those used for air, ground and water transportation. However, foreign travelers and those who are deaf or hard of hearing (DHH) or visually impaired, and others may have difficulty negotiating the same situation. There are estimated to be 28-30 million deaf and hard of hearing Americans, many of whom travel, who also need to receive this “routine and emergency” information. Deaf and hard of hearing travelers have obvious problems merely navigating the system, and because of that, forward-looking travel terminals need to do all they can to get them on the same playing field as the hearing community. In addition, foreign travel is becoming more and more common. The routine and emergency information that is vital to hearing travelers that understand the local language is just as vital to DHH and visually impaired travelers and those that do not understand the local language. It has gotten to the point that lawsuits have been filed against certain airports regarding the lack of systems to accommodate sensory impaired travelers.

This is not only true for travel terminals, but also for many other public and private facilities where it is necessary to keep people apprised of routine and emergency announcements and changes in relevant information. Some other examples are onboard cruise ships, local transportation stations, conferences, sporting events, concert events and many other venues such as convention centers and hotels. This is not only important for hearing and visually impaired persons and persons that do not understand the local language, but also for hearing persons and others that may be outside of the area in which relevant announcements are made.

The present invention can be implemented to overcome the various situations and difficulties described above.

### SUMMARY OF THE INVENTION

The notification system of the present invention includes a central computer and a plurality of hailing devices. A user registers with the notification system to be informed of announcements, changes or other information regarding an event of interest to the user. A hailing device is provided to the user, and a record is made associating the provided hailing device with the event of interest. When the notification system becomes aware of announcements, changes or other information regarding the event of interest for a registered user, the notification system transmits a notification message which is displayed or played on the hailing devices associated with the event of interest, and the hailing devices associated with the event of interest trigger an alarm signal to notify the registered user that a notification message has been received.

In different embodiments of the invention, different alarm signals can be used on the hailing devices to notify the user of a notification message. For example, the alarm signal can be visual, audible or tactile. In addition, different notification methods can be used, such as displaying the message on a screen or playing an audible message through a speaker.

In some embodiments of the invention, the user can register for one or more events of interest. In most embodiments of the invention, more than one user can register for the same event of interest.

Some embodiments of the invention can support users that do not understand the local language. For these embodiments, notification messages can be translated into a language that the user understands. Alternatively, templates can be made in a language the user understands and the fields of the template can be filled in using the applicable information from the notification message.

Additional features and advantages of the invention will become apparent to those skilled in the art upon consideration of the following detailed description of illustrated embodiments.

### BRIEF DESCRIPTION OF THE FIGURES

Aspects of the present invention are more particularly described below with reference to the following figures, which illustrate exemplary embodiments of the present invention

FIG. 1 is a schematic diagram of an exemplary embodiment of the notification system;

FIG. 2 is a diagram of an airport terminal using an embodiment of the notification system;

FIG. 3 is a diagram of an exemplary embodiment of the notification system using pagers and a paging antenna;

FIG. 4 is a diagram of an exemplary embodiment of the notification system using cellular phones;

FIG. 5 is a diagram of an exemplary embodiment of the notification system using pagers and a paging satellite; and

FIG. 6 is a diagram of an exemplary embodiment of a kiosk for dispensing registered hailing devices.

### DETAILED DESCRIPTION OF EXEMPLARY EMBODIMENTS OF THE INVENTION

For the purposes of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

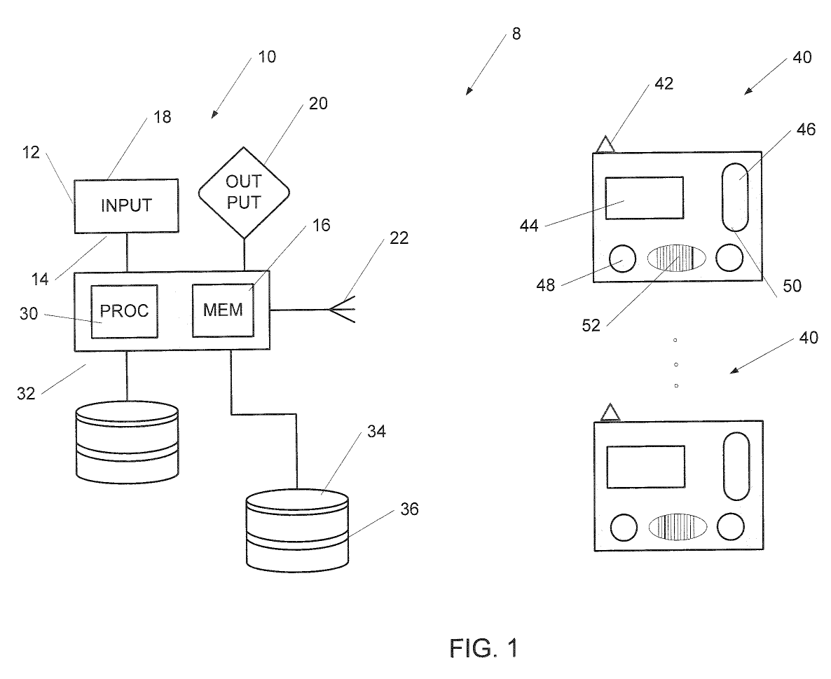

FIG. 1 shows a schematic diagram of the notification system 8 of the present invention. The notification system 8 comprises a central computer system 10 and a plurality of hailing devices 40. An activity database 34 contains a plurality of activities for which users may potentially want to be notified. A user registers with the notification system 8 to receive notifications of announcements or changes concerning an activity in the activity database 34. A notification list 30 associates hailing devices 40 with activities for which users want to be notified of announcements or changes.

The central computer system 10 comprises a rack 12 that includes a processor 14 and a memory 16. The rack 12 also includes interfaces to an input device 18, an output device 20 and a transmitter 22. The input device 18 can include a keyboard, a mouse or other data entry device. The output device 20 can include a display, a printer or other output device. The transmitter 22 is used to communicate with the plurality of hailing devices 40. The central computer system 10 also includes interfaces to the notification list 30 and the activity database 34. Either or both of the notification list 30 and the activity database 34 can be resident in the memory 16.

Each of the hailing devices 40 comprises a receiver 42, an alert signal of some type, and at least one of a display 44 and a speaker 52. The hailing devices 40 can be any of numerous electronic communication devices including but not limited to pagers, mobile telephones, personal digital assistants (PDAs), etc. When the receiver 42 with a display 44 receives a message from the central computer system 10, it displays the received message on the display 44 and activates the alert signal to notify the user that a message has been received. When the receiver 42 with a speaker 52 receives a message from the central computer system 10, it can activate the alert signal to notify the user that a message has been received, and play the received message through the speaker 52 or wait for an acknowledgement from the user and then play the message through the speaker 52. The receiver 32 wirelessly receives notification messages transmitted from the central computer system 10 through the transmitter 22. Notifications received from the central computer system 10 are displayed on the display 44 of the hailing device 40. The hailing device 40 also includes one or more alert signals which can include a tactile vibratory signal, a visual light signal, an audible sound signal or some other signal perceptible by the user.

In some embodiments, the hailing devices 40 can also enable communication with other hailing devices 40 and/or with the central computer system 10. As would be obvious to those skilled in the art, in these embodiments the hailing devices 40 also include a transmitter and in embodiments that enable communication from the hailing devices 40 to the central computer system 10, the central computer system 10 includes a receiver or network of receivers.

The hailing device 40 can also include one or more different controls. The controls shown in the embodiment of FIG. 1 include a scroll control 46, a menu button 48 and a selection button 50. The scroll control 46 is used to scroll through notifications or menus on the display 44. The menu button 48 is used to activate a hierarchy of menus to control various functions of the hailing device 40. The selection button 50 is used to select an active menu or announcement on the display 44. The selection button 50 can also be used to acknowledge an alert signal and play the latest message through the speaker 52, or to play a selected message through the speaker 52. The menu controls of the hailing device 40 can be designed to allow the user or administrator to select the type of alert signals to be used to notify the user when a notification message of interest is received. The visual light signal can be provided using the display 44 or a separate light source (not shown).

In some embodiments the hailing device 40 can store messages and the user can determine which to keep for later retrieval or playback by scrolling through previously received messages and deleting unwanted messages. In other embodiments the hailing device 40 does not store messages for later viewing or playback. For example, the hailing device 40 can display or playback only the latest message, or display or queue for playback a message until it is acknowledged by the user and then allow the acknowledged message to be replaced by a later message, a first-in-first-out queue. Those skilled in the art will understand that there are many other variations of message management that can be used in different embodiments of the hailing device and the notification system 8.

When a user registers with the notification system 8, the user indicates an activity of interest 36 in the activity database 34 for which the user wants to be notified of announcements and changes. The user receives a registered hailing device 40A, the registered hailing device 40A being one of the plurality of hailing devices 40, and a notification entry 32 is made in the notification list 30 which associates the registered hailing device 40A with the activity of interest 36 in the activity database 30. In some embodiments, some of the users may already have a hailing device 40 that operates with the notification system 8. In these embodiments, the user's hailing device 40 is used as the registered hailing device 40A and the notification entry 32 in the notification list 30 associates the user's registered hailing device 40A with the activity of interest 36 in the activity database 30. For example, in an embodiment with cell phones as the hailing devices 40, the user's cell phone number can be included in the notification entry 32.

In some embodiments, a user can register for multiple activities of interest 36 in the activity database 30. In this case, as before, the user receives a registered hailing device 40A, or the user's hailing device 40 is registered as the registered hailing device 40A. Multiple notification entries 32 are made in the notification list 30, each of the notification entries 32 associating the registered hailing device 40A with the activity of interest 36. Alternatively, a single notification entry 32 could be made in the notification list 30 which associates the registered hailing device 40A with all of the activities of interest 36. In either case, when an announcement or change is made concerning any of the activities of interest 36, then a notification message is sent to the registered hailing device 40A.

Multiple users can register for the same activity of interest 36 in the activity database 30. In this case, each of the users receives a registered hailing device 40A, or a user's hailing device 40 is registered as the registered hailing device 40A. Multiple notification entries 32 are made in the notification list 30 and each of the notification entries 32 associates one of the registered hailing devices 40A with the activity of interest 36. Alternatively, a single notification entry 32 could be made in the notification list 30 in which case the notification entry 32 associates all of the registered hailing devices 40A with the activity of interest 36. In either case, when an announcement or change is made concerning the activity of interest 36, then a notification message is sent to all of the registered hailing devices 40A. These notification messages can be sent as individualized messages to “Mr. Smith” and “Mrs. Jones” for each of the registered hailing devices 40A, or as a general notification message to all of the registered hailing devices 40A.

The activity database 30 is monitored to watch for announcements or changes concerning any of the activities of interest 36. This monitoring of the activity database 34 can be done manually by an administrator or automatically by the computer system 10. In manual monitoring, when the administrator becomes aware of an announcement or change concerning an activity of interest 36, the administrator creates a notification message in the central computer system 10 using the input devices 18 and sends the notification message to the users associated with that activity of interest 36 based on the notification list 32. In automatic monitoring, the central computer system 10 monitors the activity database 34 for any changes in an activity of interest 36 and monitors for any announcements concerning an activity of interest 36. When an announcement or change is detected concerning an activity of interest 36, the central computer system 10 creates a notification message and sends the notification message to the users associated with that activity of interest 36 based on the notification list 32.

The notification message is transmitted through the transmitter 22 coupled to the central computer system 10 and is wirelessly received by the hailing devices 40. When one of the hailing devices 40 receives a notification message concerning an activity of interest 36 with which it is associated, the hailing device 40 activates one or more of the alert signals to alert the user that a notification message has been received.

When the notification system 8 is used in a small area, the transmitter 22 of the central computer system 10 can be a wireless transmitter that directly transmits the notification messages to the receivers 42 of the hailing devices 40. When the notification system 8 is used in larger areas, the transmitter 22 can include a plurality of transmitters wired or wirelessly coupled to the central computer system 10 through which the notification message is wirelessly sent to the receivers 42 of the hailing devices 40. The notification system 8 can also include repeaters that receive notification messages from the transmitter 22 and then repeat the message, usually with a stronger signal strength to enlarge the area covered by the notification system 8.

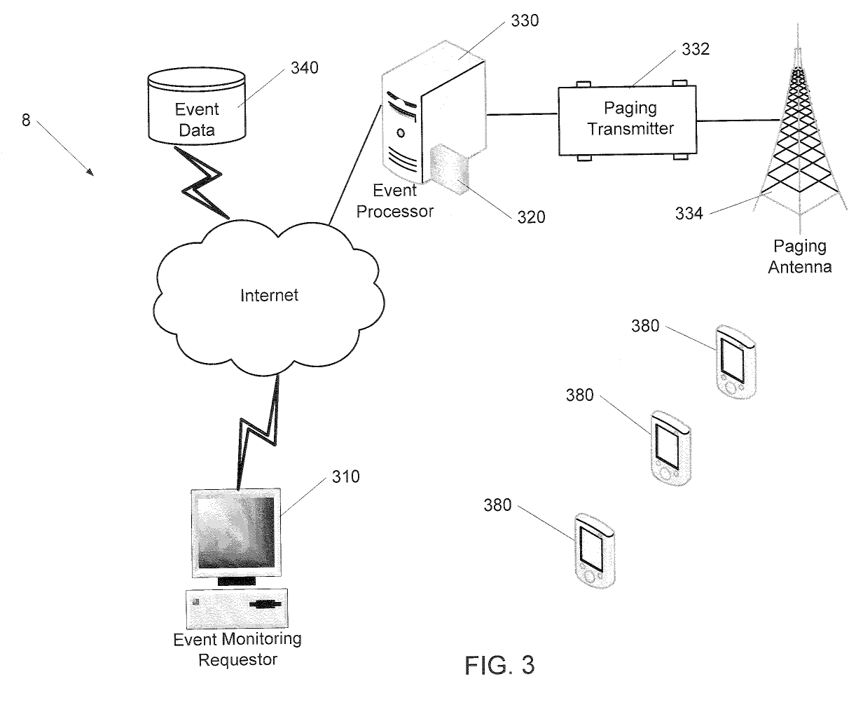

FIGS. 3-5 show some alternative embodiments of the notification system 8. The embodiment of the notification system 8 shown in FIG. 3 comprises an event monitoring requestor 310, an event database 340, an event processor 330, a notification list 320 and a plurality of hailing devices 380, and uses paging technology to connect the event processor 330 with the plurality of hailing devices 380. In FIG. 3 an event monitoring requestor 310 registers users with events stored in an event database 340 and this information is used to create a notification list 320 used by an event processor 330 to notify users of announcements concerning events of interest. FIG. 3 shows the event monitoring requester 310, the event database 340 and the event processor 330 located remotely from each other and connected through the Internet. Of course, any other network or a combination of local and wide-area networks can be used to allow communication between the event monitoring requestor 310, the event database 340 and the event processor 330. Alternatively, the event monitoring requestor 310, the event database 340 and the event processor 330 can be integrated in a single computer.

A user that wants to be notified of changes or other announcements regarding an event of interest stored in the event database 340 goes to the event monitoring requestor 310. Using input/output devices at the event monitoring requestor 310, an administrator registers the user for the event(s) of interest in the event database 340 and issues or registers a hailing device 380 for the registered user. The administrator registers the user by creating an entry in the notification list 320 associating the registered hailing device 380 and the user with the event of interest. The administrator can also update the notification list 320 using the input/output devices at the event monitoring requestor 310, for example, if the user wishes to add or delete event(s) of interest for which they wish to be notified. The notification list 320 and the event database 340 are used by the event processor 330. The event processor 330 monitors the event database 340 and any other relevant information sources for changes and other announcements regarding the registered event(s) of interest in the notification list 320. When the event processor 330 detects a change or announcement regarding the event(s) of interest, the event processor 330 searches the notification database 320 to determine the registered hailing device(s) 380 and associated user(s) to be notified, and creates notification message(s) to be sent to the registered hailing device(s) 380. The event processor 330 transmits the notification message(s) to the registered hailing device(s) using a paging transmitter 332 and a paging antenna 334.

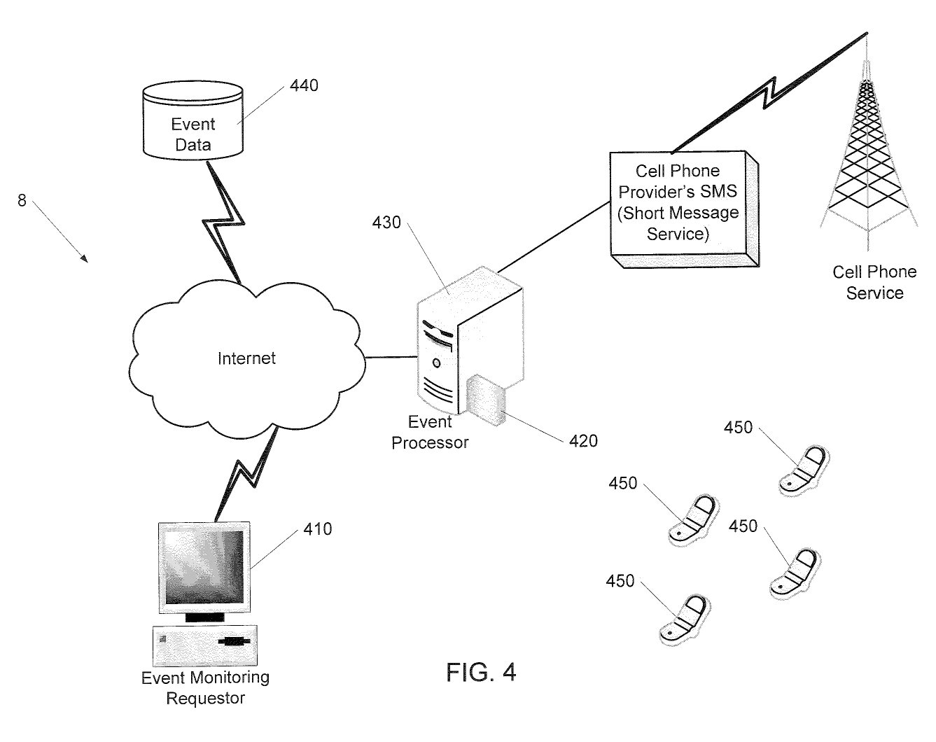

The embodiment of the notification system 8 shown in FIG. 4 comprises an event monitoring requestor 410, an event database 440, an event processor 430, a notification list 420 and a plurality of hailing devices 450, and uses cellular technology to connect the event processor 430 with the plurality of hailing devices 450. An event monitoring requester 410 registers users with events stored in an event database 440 and this information is used to create a notification list 420 used by an event processor 430 to notify users of announcements concerning events of interest. FIG. 4 shows the event monitoring requestor 410, the event database 440 and the event processor 430 located remotely from each other and connected through the Internet. As before, the event monitoring requestor 410, the event database 440 and the event processor 430 can be integrated in a single computer, or interconnected over a combination of local and wide-area networks or any other communication network that supports communication between them.

A user that wants to be notified of changes or other announcements regarding an event of interest stored in the event database 440 goes to the event monitoring requester 410. Using input/output devices at the event monitoring requestor 410, an administrator registers the user for the event(s) of interest in the event database 440 and registers a cell phone 450A of the plurality of cell phones 450 for the registered user. If the registered user does not already have a cell phone 450, then one is issued to the user. The administrator registers the user by creating an entry in the notification list 420 associating the registered cell phone 450A with the user and with the event of interest. The administrator can also update the notification list 420 using the input/output devices at the event monitoring requestor 410, for example, if the user wishes to add or delete event(s) of interest for which they wish to be notified. The notification list 420 and the event database 440 are used by the event processor 430. The event processor 430 monitors the event database 440 and any other relevant information sources for changes and other announcements regarding the registered event(s) of interest in the notification list 420. When the event processor 430 detects a change or announcement regarding the event(s) of interest, the event processor 430 searches the notification database 420 to determine the registered cell phone(s) 450A and the associated user(s) to be notified. The event processor 430 also creates notification message(s) to be sent to the registered hailing device(s) 450A which are preferably personalized for the individual registered user. The event processor 430 transmits the notification message(s) to a cell phone provider's service 432 which transmits the message through a cell phone antenna 434. Each of the registered cell phone(s) 450A then receives the notification message and alerts the user that a new notification message has been received. The notification message can be displayed on the cell phone display and/or, when the user acknowledges the alert signal, the notification message can be played through the cell phone speaker.

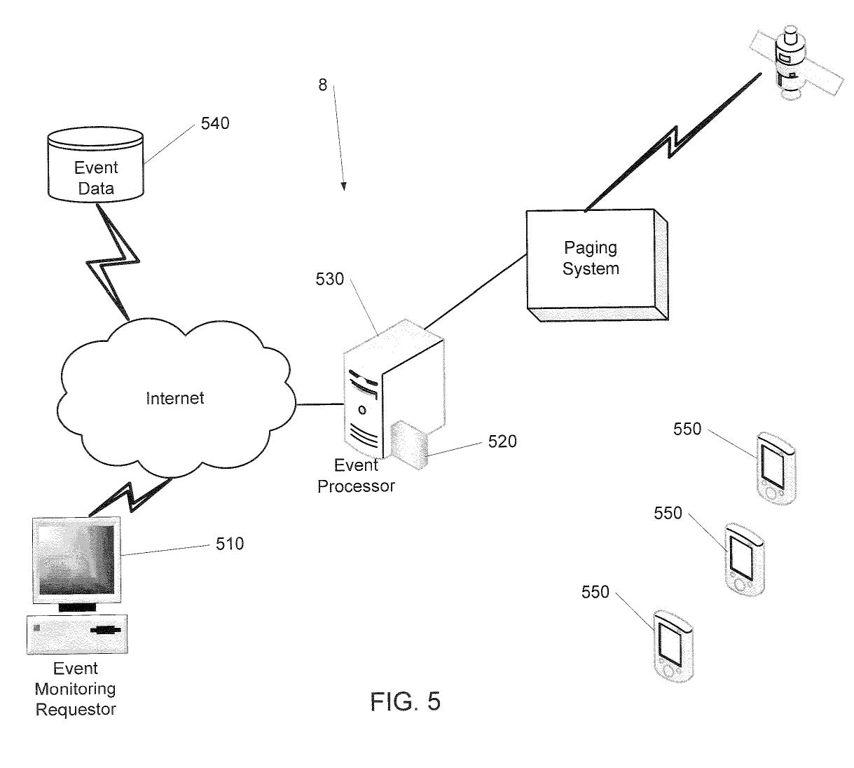

The embodiment of the notification system 8 shown in FIG. 5 comprises an event monitoring requestor 510, an event database 540, an event processor 530, a notification list 520 and a plurality of hailing devices 550, and uses a satellite-implemented paging service to connect the event processor 530 with the plurality of hailing devices 550. An event monitoring requestor 510 registers users with events stored in an event database 540 and this information is used to create a notification list 520 used by an event processor 530 to notify users of announcements concerning events of interest. FIG. 5 shows the event monitoring requestor 510, the event database 540 and the event processor 530 located remotely from each other and connected through the Internet. As before, the event monitoring requestor 510, the event database 540 and the event processor 530 can be integrated in a single computer, or interconnected over a combination of local and wide-area networks or any other communication network that supports communication between them.

A user that wants to be notified of changes or other announcements regarding an event of interest stored in the event database 540 goes to the event monitoring requester 510. Using input/output devices at the event monitoring requestor 510, an administrator registers the user for the event(s) of interest in the event database 540 and registers a pager 550A of the plurality of pagers 550 for the registered user. If the registered user does not already have a pager 550, then one is issued to the user. The administrator registers the user by creating an entry in the notification list 520 associating the registered pager 550A with the user and with the event of interest. The administrator can also update the notification list 520 using the input/output devices at the event monitoring requester 510, for example, if the user wishes to add or delete event(s) of interest for which they wish to be notified. The notification list 520 and the event database 540 are used by the event processor 530. The event processor 530 monitors the event database 540 and any other relevant information sources for changes and other announcements regarding the registered event(s) of interest in the notification list 520. When the event processor 530 detects a change or announcement regarding the event(s) of interest, the event processor 530 searches the notification database 520 to determine the registered pager(s) 550A and the associated user(s) to be notified. The event processor 530 also creates notification message(s) to be sent to the registered hailing device(s) 550. The event processor 530 transmits the notification message(s) to a paging system 532 which transmits the message(s) through a satellite 534. Each of the registered pager(s) 550A then receives the notification message and alerts the user that a new notification message has been received. The notification message can be displayed on the pager display and/or, if the pager is equipped with a voice speaker, when the user acknowledges the alert signal, the notification message can be played through the speaker of the pager.

The notification system has been generally described above, with some details and alternatives concerning different embodiments of the system. Those skilled in the art, will be aware of many other alternatives and embodiments that fall within the spirit of the description provided.

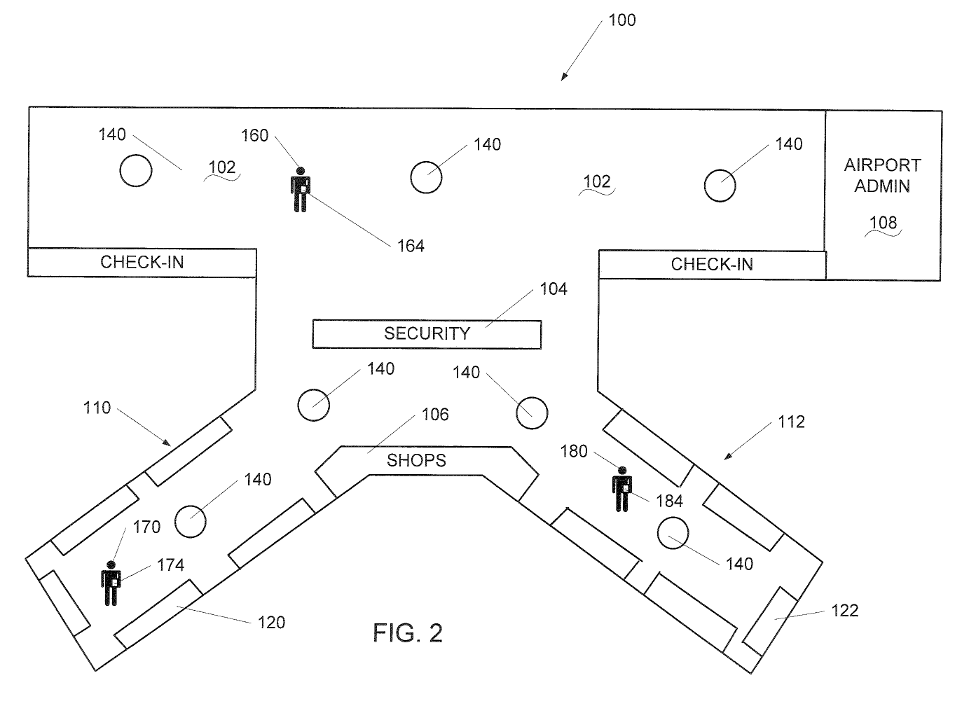

FIG. 2 shows an exemplary embodiment of the present invention implemented in an airport terminal 100. The airport terminal 100 comprises a check-in area 102, a security area 104, a shop area 106, an administrative area 108, a first concourse 110 and a second concourse 112. The check-in area 102, in this example, is where a person checks in with the airline for their flight and checks any luggage to be stowed in the cargo area of the airplane. The person must then proceed through the security area 104 before proceeding to a gate in either of the first concourse 110 or the second concourse 112. This example parallels the implementation of the present invention in numerous other venues, including but not limited to cruise ships, train stations, hotels, convention centers, and sporting event locations.

FIG. 2 shows a plurality of transmitters 140 located in various areas of the terminal 100, each transmitter 140 being operatively coupled to the central computer system 10. In alternative embodiments, where a smaller area is to be covered by the system or where a single transmitter 140 is capable of reaching the entire terminal or other venue, a single transmitter 140 can be used. The central computer system 10 of the notification system can be located in the administrative area 108 of the airport terminal 100, and notification messages transmitted throughout the public areas of the terminal 100 through the transmitters 140. In the airport environment, it is preferable to have the central computer 10 interface with the Flight Information Display System (FIDS) used by many airports to update flight monitors throughout the airport. When a change is sent through the FIDS system, the central computer 10 detects the change and can issues an appropriate notification message to one or more of the plurality of transmitters 140.

A traveler entering the airport terminal 100 proceeds initially to the check-in area 102 to check in for their flight. When the traveler checks in for their flight, they learn the status of their flight (on time, delayed, cancelled, etc.), the estimated departure time, and the gate that their flight is currently scheduled to depart from. Though the information is current when provided, any of this information can change and other relevant information can become later available. The traveler can request a hailing device 40 to be kept informed of announcements or changes regarding their flight. The traveler then proceeds through the security area 104. Once cleared through the security area 104, the traveler can proceed into the gate area that comprises the shop area 106 and the two concourses 110, 112.

FIG. 2 shows first, second and third travelers 160, 170 and 180 which each have a registered hailing device 164, 174, 184 respectively. Assume that the second traveler 170 and the third traveler 180 are both registered for an affected flight that is scheduled to depart from gate 120 of the first concourse 110; and that the first traveler 160 is registered for a different flight and is not interested in changes or announcements regarding the affected flight. The second traveler 170 is waiting at the scheduled departure gate 120 and the third traveler 180 has gone outside the announcement area for the affected flight in order to go to the shop area 106 and get something to eat.

If the departure gate for the affected flight is moved from gate 120 of the first concourse 110 to gate 122 of the second concourse 112, an announcement will be made in the area near gate 120 to notify passengers of the change in departure gate. When the notification system 8 becomes aware of this change, the central computer system 10 will be used to notify the registered users associated with the affected flight using the transmitters 140 and the hailing devices 40.

For emergency messages and routine messages intended for all users, the central computer system 10 transmits a general notification message to all of the hailing devices 40. In this embodiment, each of the hailing devices 164, 174 and 184 receives the general notification message and activates its alert signal. The hailing devices 164, 174 and 184 can display the general notification message on their respective displays, or if equipped with a speaker, play the general notification message through their speakers, or await a user acknowledgement to do one of the above, or otherwise communicate the notification message to the traveler. The travelers 160, 170 and 180, who may be hearing or visually impaired or may not understand the language of the announcement, will sense the alert signal of their hailing device 164, 174 and 184, respectively, and look at the display of their hailing device for the notification message or acknowledge the notification message for display or playback. The notification message would be the same for all of the travelers, for example “There is a fire alarm in the Second Concourse 112, please leave the Second Concourse immediately.”

For messages concerning a specific activity of interest or user, the central computer system 10 sends a notification message to only the hailing devices 40 associated with the activity of interest or user that has an announcement or change. In this embodiment, the notification messages can be personalized to include the traveler's name or other personal information. For instance, the notification message to the second traveler 174 could read “Mr. Graves, the departure gate for Air Carrier flight 32 from Newark, N.J. to Birmingham, UK has been moved to Gate 122 of the Second Concourse 112.”

For foreign travelers, a hailing device 40 is provided to the foreign traveler that will display messages in a language understood by the foreign traveler. This can be done by having translations of standard notification messages made into templates in the foreign language. Then when an actual notification message is sent, the relevant parameters are inserted into the foreign language template. For the above example, an English template may look like “The departure gate for [AIRLINE NAME] flight [FLIGHT NUMBER] to [DESTINATION] has been moved to Gate [NEW GATE NUMBER] of Concourse [NEW CONCOURSE NAME],” where the bracketed terms are parameters that are filled in using the applicable information from the notification message. The standard messages for an airport environment could include gate change, flight delay, see gate agent, or other routine announcement or safety messages.

An implementation of the present invention in a cruise ship environment can be used, similar to the above example, to keep passengers apprised of ship board activities they have signed up for and other routine and emergency announcements. A two-way communication embodiment allowing communication between hailing devices 40 and between the hailing devices 40 and the central computer 10 can also be used in a cruise ship environment. The two-way communication between hailing devices 40 can aid DHH travelers who want to send TEXT or SMS messages to each other aboard ship. The communication between the hailing devices 40 and the central computer 10 can enable a passenger to reply to a message he/she receives, or to make an appointment, such as a dinner reservation or haircut appointment. And when the hailing device 40 includes calendaring functionality, such as in a PDA, the hailing device can automatically update the calendar to include the appointment.

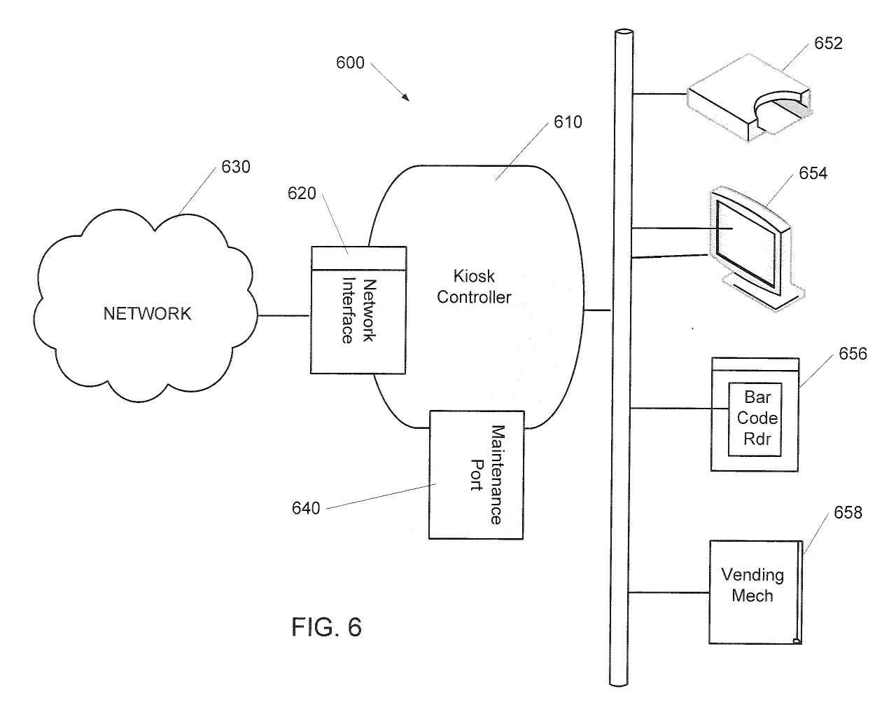

In some embodiments, the hailing devices 40 can also be dispensed by automated kiosks that will accept activity and credit card information from a passenger, and send the information to the central computer 10 or the event processor. An exemplary block diagram for a kiosk 600 for dispensing hailing devices 40 is shown in FIG. 6. The kiosk 600 includes a kiosk controller 610 connected to a network interface 620, a maintenance port 640 and a peripheral bus 650. The network interface 620 enables the transmission of information between the kiosk 600 and the central computer 10 or an event processor 330, 430, 530. The maintenance port 640 enables maintenance and diagnostic checks to be performed on the kiosk 600. The peripheral bus 650 connects the kiosk controller 610 to a card reader 652, a touch screen display 654, a bar code reader 656 and a vending mechanism 658.

In some embodiments of the kiosk 600, the card reader 652 can be capable of reading the magnetic strip on a credit card to obtain payment information and/or user information. Embodiments of the kiosk 600 can also include interfaces to accept alternative forms of payment.

In some embodiments of the kiosk 600 designed for use in airport terminals, the bar code reader 656 can be capable of reading the bar code defined by IATA Resolution 792 for bar coded boarding passes. This enables the kiosk 600 to collect a variety of information about the user and the activity of interest, including passenger name, operating carrier, departure city, destination city, airline designator, flight number, date of flight and seat number.

The kiosk 600 can dispense and register a hailing device 40 to a user that wants to be notified of announcements for an activity of interest. The user can register for an event of interest using the touch screen 654 or the bar code reader 656. The user can provide payment information using the card reader 652. In some embodiments, the kiosk 600 confirms the payment with a credit card processing system through the network interface 620 before dispensing a hailing device 40 to the user. When the kiosk 600 receives the necessary registration and payment information, the kiosk 600 dispenses a hailing device 640 through the vending mechanism 658 to the user, and sends a registration message to the event monitoring system through the network interface 620. The registration message associates the dispensed hailing device 640 with the activity of interest. The registration message can also include information associating the user with the dispensed hailing device 640 and the activity of interest.

The present invention has been illustrated and described with reference to certain exemplary embodiments, variations, and applications. The same is to be considered illustrative and not restrictive in character, it being understood that only some exemplary embodiments have been shown and described and that all changes and modifications that come within the spirit of the invention are desired to be protected. The present invention is defined by the appended claims and therefore should not e limited by the described embodiments, variations, and applications.

We claim:

1. A notification system for notifying a user of activity announcements, the notification system comprising:
an central computer;
an event database containing a plurality of events;
a plurality of hailing devices, each of the plurality of hailing devices having a receiver;
a transmitter connected to the central computer, the transmitter being capable of sending messages from the central computer to the plurality of hailing devices; and
a notification list accessible by the central computer, the notification list associating an event of interest with a registered hailing device, the event of interest being one of the plurality of events in the event database and the registered hailing device being one of the plurality of hailing devices;
wherein when the central computer receives announcements concerning the event of interest, the central computer sends a notification message through the transmitter to the receiver of the registered hailing device, and the registered hailing device notifies the user of the notification message.

2. The notification system of claim 1, wherein the central computer comprises:
an event monitoring requester, the event monitoring requestor associating the event of interest with the registered hailing device for entry in the notification list; and
an event processor, the event processor being informed of announcements, searching the notification list, and sending the notification message to the plurality of hailing devices.

3. The notification system of claim 1, further comprising a kiosk for automatically dispensing a kiosk hailing device, each kiosk hailing device being one of the plurality of hailing devices.

4. The notification system of claim 3, wherein the kiosk comprises:
a display screen providing a user interface;
a bar code reader for receiving user input;
a credit card reader for receiving payment information;
a vending mechanism for dispensing the kiosk hailing device; and
a network interface for exchanging information with the central computer.

5. The notification system of claim 4, wherein the bar code reader of the kiosk is capable of reading a bar code defined by the International Air Transport Association.

6. The notification system of claim 1, wherein each of the plurality of hailing devices includes an alert signal, wherein when a receiving hailing device of the plurality of hailing devices receives a message sent to the receiving hailing device from the central computer, the receiving hailing device activates the alert signal to notify the user that a message has been received.

7. The notification system of claim 6, wherein the alert signal is at least one of a visual alert signal, an audible alert signal and a tactile alert signal.

8. The notification system of claim 7, wherein each of the plurality of hailing devices includes a mechanism for selecting at least one of the visual alert signal, the audible alert signal and the tactile alert signal.

9. The notification system of claim 6, wherein the plurality of hailing devices includes an audible hailing device, the audible hailing device including a speaker and a user acknowledge mechanism, wherein when the audible hailing device receives a message sent to the audible hailing device from the central computer, the audible hailing device activates the alert signal to notify the user that a message has been received and, when the user activates the user acknowledge mechanism, the audible hailing device plays the message through the speaker of the audible hailing device.

10. The notification system of claim 1, further comprising a plurality of transmitters connected to the central computer, each of the plurality of transmitters being capable of sending messages from the central computer to the plurality of hailing devices.

11. The notification system of claim 1, further comprising a repeater for extending the range of the notification system, wherein when the repeater receives the notification message, the repeater resends the notification message.

12. The notification system of claim 1, wherein the notification system uses paging technology, the transmitter is a paging transmitter and the plurality of hailing devices are pagers.

13. The notification system of claim 1, wherein the notification system uses cellular technology, the transmitter sends the notification message to a cell phone provider service for transmission, and the plurality of hailing devices are cellular telephones.

14. The notification system of claim 1, wherein the notification system includes an interface to a Flight Information Display System and the central computer monitors the Flight Information Display System for announcements concerning the event of interest.

15. A method of notifying users of announcements concerning activities of interest using a plurality of hailing devices, the method comprising:
associating a registered hailing device of the plurality of hailing devices with each user, each of the plurality of hailing devices having a hailing device identifier;
maintaining a notification list containing a plurality of entries, each entry containing a hailing device identifier and an activity identifier;
monitoring an activity database containing announcements concerning a plurality of activities, each of the plurality of activities having an activity identifier;
for each user registering for an activity of interest; making a notification list entry containing the hailing device identifier for the registered hailing device associated with the user and the activity identifier for the activity of interest, the activity of interest being one of the plurality of activities in the activity database;
performing the following steps when a new announcement is detected for a monitored activity, the monitored activity being one of the plurality of activities in the activity database:
searching the notification list for all relevant entries, each relevant entry having the activity identifier for the monitored activity; and
for each relevant entry,
determining the affected hailing device associated with the monitored activity; and
sending a notification message to the affected hailing device.

16. The method of claim 15, wherein the step of associating a registered hailing device includes providing the registered hailing device to the user.

17. The method of claim 15, wherein the step of associating a registered hailing device includes obtaining the hailing device identifier from the user.

18. The method of claim 15, wherein the step of sending a notification message further comprises, for each relevant entry:
determining the affected user associated with the affected hailing device; and
creating a personalized notification message for the affected user.

19. The method of claim 15, further comprising:
receiving the notification message by the affected hailing device;
activating an alarm signal on the affected hailing device; and
displaying the notification message on the affected hailing device.

20. The method of claim 15, further comprising:
receiving the notification message by the affected hailing device;
activating an alarm signal on the affected hailing device;
awaiting a user acknowledgement of the alarm signal; and
playing the notification message on the affected hailing device.

21. The method of claim 15, wherein each notification list entry includes a language identifier identifying a language;
the step of making a notification list entry further comprising, entering the language identifier for the user; and
the step of sending a notification message to the affected hailing device further comprising, translating the notification message to the language identified by the language identifier.

22. The method of claim 15, wherein each notification list entry includes a language identifier identifying a language;
the step of making a notification list entry further comprising, entering the language identifier for the user; and
the step of sending a notification message to the affected hailing device further comprising:
selecting a template for the language identified by the language identifier; and
creating the notification message by filling in the template with necessary information from the announcement.

23. The method of claim 15, further comprising:
accepting a general announcement to be sent to all users;
sending a general notification message to all registered hailing devices containing information from the general announcement.
